(19) United States
(12) Patent Application Publication
(10) Pub. No.: US 2009/0265521 A1
(43) Pub. Date: Oct. 22, 2009

(54) PATTERN PROTECTION METHOD AND CIRCUIT

(75) Inventors: Yu-hsuan Lin, Taichung City (TW); Jin-bin Yang, Sihu Township (TW); Shu-hung Chou, Sanchong City (TW)

Correspondence Address: KIRTON AND MCCONKIE, 60 EAST SOUTH TEMPLE,, SUITE 1800, SALT LAKE CITY, UT, 84111, US

(73) Assignee: MEDIATEK INC., Hsin-Chu (TW)

(21) Appl. No.: 12/105,743

(22) Filed: Apr. 18, 2008

(51) Int. Cl. G06F 12/16

(52) U.S. Cl. 711/163; 711/E12.103

(57) ABSTRACT

The present invention discloses an address protection method and circuit capable of efficiently protecting inputting addresses from corruption. The predictable order of a series of original addresses is checked and then the correct addresses are generated by correcting the corrupted addresses within the original addresses. The address protection method and circuit according to the present invention can improve the accuracy of the inputting addresses and increase the validity of data in response to the inputting addresses.

### FIELD OF THE INVENTION

The present invention generally relates to a method and a circuit for address protection of a disk, and more particularly, to a method and a circuit for protecting the addresses from corruption.

### BACKGROUND OF THE INVENTION

In a DVD-RW (Digital Versatile Disc-Rewritable)/DVD-R (Digital Versatile Disc-Recordable) system, the DVD data are recorded on the disk by land tracks and groove tracks. The groove tracks are functioned as guide grooves. Each groove track has a slightly wobbled structure, which is normally referred to as a guiding structure. A plurality of address pits, which are referred to as land pre-pits (LPPs), are formed in land tracks between the groove tracks. The DVD-RW/DVD-R system traces the wobble and the LPPs to generate a wobble signal and an LPP signal, which carry record address information of the disk or a synchronization pattern for writing data. The wobble signal and the LPP signal are decoded to retrieve the address information and the synchronization pattern in order to accurately write data to a predetermined recording area on the disk.

FIG. 1 shows a structure diagram of conventional pre-pit data block. As shown in FIG. 1, sixteen pre-pit physical sectors construct a pre-pit data block. The pre-pit data block comprises two data parts, ECC block addresses and field ID/disc information. The pre-pit data block further comprises parity data such as parity A and parity B respectively corresponding to the ECC block address and field ID/disc information. A sequence of the pre-pit data corresponds to the sixteen pre-pit physical sectors. The pre-pit data block comprises an SYNC code, relative addresses and the data, and one part of the SYNC code corresponds to one part of each pre-pit physical sector (such as one raw). The relative addresses indicate the positions of the ECC (Error Correction Code) block addresses and field ID/disc information. The relative address also indicates the start position of the pre-pit data block. As known, parity A and parity B are used to check data correctness and integrity. Pre-pit information of Part A shall be the ECC block address, while pre-pit information of Part B shall be recorded in the disc information fields of Part B. The contents of the disc information are classified and distinguished by field ID. The contents of disc information include ECC block address, application code, manufacturer ID and the like.

However, the relative address is a raw data and not protected by any error correction method. This causes the relative address to be vulnerable and easily be corrupted. The start position of the pre-pit data block can not be accurately identified if the relative address is corrupted. Therefore, there is a need to provide an address protection method and an address protection circuit for maintaining the accuracy of the inputting addresses, such as the relative addresses.

### SUMMARY OF THE INVENTION

It is an object of the present invention to provide a method for protecting inputting addresses from corruption.

It is another object of the present invention to provide a circuit for protecting inputting addresses from corruption.

According to a first aspect of the invention, the present invention sets forth An address or pattern protection method comprising the steps of generating and checking a series of generated addresses (or patterns) according to a predictable order implied by a series of original addresses (or patterns); generating a recognized address (or pattern) when the generated addresses (or patterns) comply with the predictable order, wherein the recognized address (or pattern) is selected from the generated addresses (or patterns); checking whether the original addresses (or patterns) comply with the generated address (or pattern) for first predetermined times; and setting the recognized address (or pattern) in a lock state when the original addresses (or patterns) comply with the generated addresses (or patterns) for the first predetermined times.

According to another aspect of the invention, the present invention sets forth an address or pattern protection circuit comprising a sequence generator for generating a series of generated addresses (or patterns) according to a predictable order implied by a serious of original addresses; a match circuit for checking the predictable order of the original addresses (or patterns) and comparing the generated addresses (or patterns) with the original addresses (or patterns) and then generating a match result, and the match circuit generating a recognized address (or pattern) when the generated addresses (or patterns) comply with the predictable order, wherein the recognized address (or pattern) is selected from the generated addresses (or patterns); and a lock state indicator for issuing a lock state signal for indicating whether the recognized address is in a lock state according to the match result generated by the match circuit, wherein the recognized address (or pattern) is in the lock state when the original addresses are verified to comply with the generated addresses for first predetermined times.

### BRIEF DESCRIPTION OF THE DRAWINGS

FIG. 1 illustrates an example of a pre-pit data block.

FIG. 2 illustrates a block diagram of an address protection circuit in accordance with the present invention.

FIG. 3 illustrates a flowchart of an address protection method in accordance with the present invention.

FIGS. 4-7 show the exemplary situations for checking and protecting the validity of the inputting addresses.

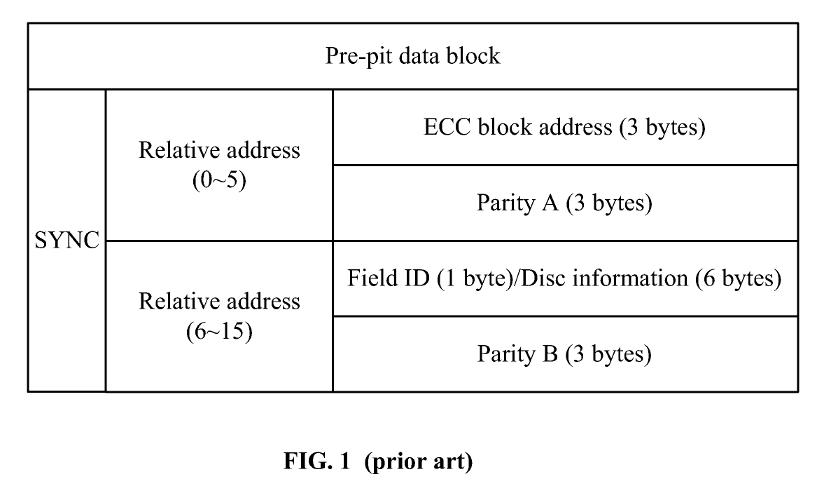

### DETAILED DESCRIPTION OF THE PREFERRED EMBODIMENTS

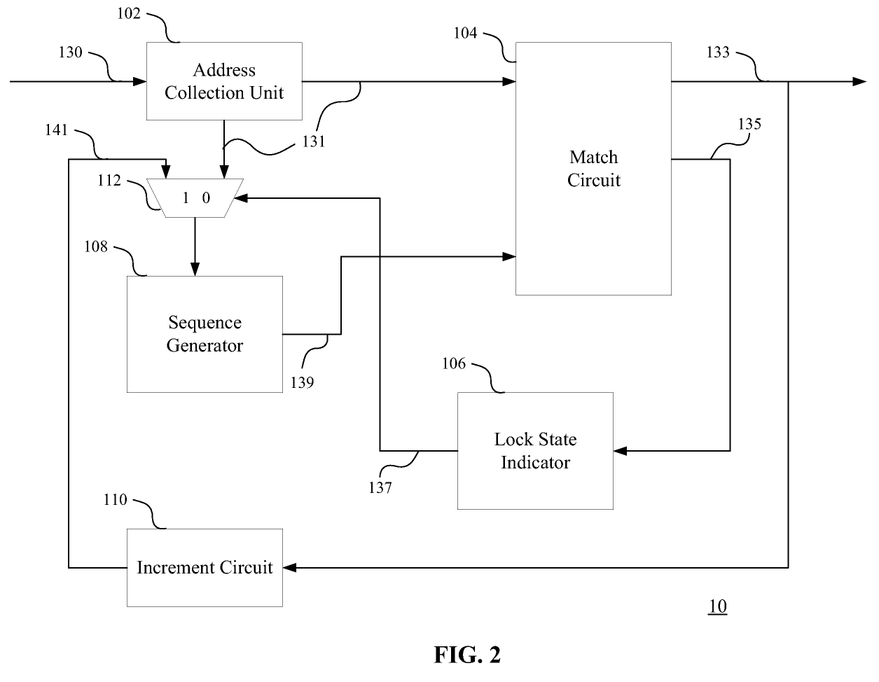

FIG. 2 illustrates a block diagram of an address protection circuit 10 in accordance with the present invention. The address protection circuit 10 comprises a match circuit 104, a lock state indicator 106, a sequence generator 108, an increment circuit 110, and a multiplexer 112. Moreover, the address protection circuit 10 further has an address collection unit 102 to collect a plurality of inputting addresses 130 and then outputs a series of original addresses 131 in correspondent to the inputting addresses 130. It is noted that the inputting addresses are the addresses need to be protected. The sequence generator 108 is used to generate a series of generated addresses 139 according to a predictable order implied by the original addresses 131. The predictable order may be represented by a continuous sequential order or any other predetermined rule.

After the address collection unit 102 collects a predetermined number (e.g. 5) of inputting address 130 and outputs as a series of original addresses 131, the original addresses 131 and the generated addresses 139 of the same number (e.g. five addresses) are both inputted into the match circuit 104 in one predetermined period. The predetermined period is used for collecting the predetermined number of the inputting addresses 130 to obtain the trend and determine the sequential orders of the address. The generated addresses 139 and the original addresses 131 of the same number are compared by the match circuit 104 in one predetermined period. The number of the generated addresses 139 and the original addresses 131 can be set based on a designer or user'demand. The match circuit 104 compares the generated addresses 139 with the original addresses 131 and checks whether the generated addresses 139 comply with the predictable order implied by the original addresses 131.

The predictable order can be determined according to a majority order implied by the plurality of the original addresses 131. The majority order means that the majority of sequential order of the original addresses 131. That is, the greatest conformity exists between the actual sequential order of the series of original addresses 131 and the predictable order derived from the majority of sequential order. For example, there may be two assumed sequential orders for original addresses [3, 2, 5, 4, 7] as [3, 4, 5, 6, 7] and [1, 2, 3, 4, 5], which are respectively implied by the addresses “3”, “5”, “7” and addresses “2”, “4”. However, the majority order of the addresses “3”, “2”, “5”, “4” and “7” should be an address order of “3”, “4”, “5”, “6” and “7”, because the address order implied by the addresses “3”, “5” and “7” overwhelms the address order implied by the addresses “2” and “4”. For the assumed sequential order of [3, 4, 5, 6, 7], there are two addresses 2, 4 of the actual sequential order [3, 2, 5, 4, 7] not in conformity with the assumed sequential order. For the assumed sequential order of [1, 2, 3, 4, 5], there are three address 3, 5, 7 are not in conformity with the assumed sequential order. Therefore, the assumed sequential order [3, 4, 5, 6, 7] is selected as the predictable order.

The match circuit 104 outputs a recognized address 133 at a time if the match circuit 104 determines that the generated addresses 139 comply with the predictable order implied by the original addresses 131 in one predetermined period. The recognized address 133 is selected from the generated addresses 139 if the correctness of the order of the generated addresses 139 is confirmed by the match circuit 104. In the meanwhile, the match circuit 104 outputs a match result 135 to the lock state indicator 106 for indicating the comparison result of the generated addresses 139 and the original addresses 131.

The lock state indicator 106 is used to indicate whether the recognized address 133 is in a lock state. The lock state means that the recognized address has been successfully verified. The recognized address 133 is supposed to be in the lock state when the generated addresses 139 are checked and determined to be complying with the predictable order of the original addresses 131 for first predetermined times (e.g. two times). The number of the first predetermined times can be set based on designer or user'demand. The lock state indicator 106 outputs a lock state signal 137 to control the multiplexer 112. The multiplexer 112 receives the original address 131 from the address collection unit 102 and a series of incremental addresses 141, which will be further described later, from the increment circuit 110. The multiplexer 112 outputs the incremental addresses 141 to the sequence generator 108 when the recognized addresses 133 are supposed to be in the lock state and the sequence generator 108 outputs the generated addresses 139 accordingly, otherwise the multiplexer 112 outputs the original addresses 131 to the sequence generator 108. The series of incremental addresses 141 outputted by the increment circuit 110 are generated by an ascending or descending order counted from the last recognized address 133 in response to the predictable order. That is, the last recognized address 133 is used as a reference. The sequence generator 108 directly outputs the incremental addresses 141 as the generated addresses 139 when the recognized addresses 133 are supposed to be in the lock state.

By the address protection circuit 10 described in FIG. 2 above, the sequential order of addresses is effectively predicted and verified, and therefore be protected by eliminating influence due to address corruption.

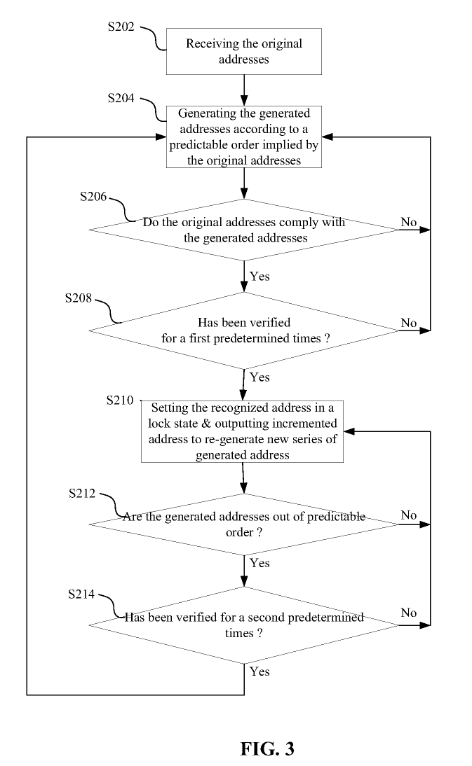

FIG. 3 illustrates a flowchart of an address protection method in accordance with the present invention. The address protection method comprises following steps of:
S202 The address collection unit 102 receives a plurality of inputting addresses 130 and then outputs a plurality of original addresses 131 in response to the inputting addresses 130. The match circuit 104 receives the original addresses 131 outputted from the address collection unit 102.
S204 The sequence generator 108 generates a series of the generated addresses 139 according to a predictable order implied by the original addresses 131. The predictable order may be represented by a continuous sequential order or a predetermined rule. The same number count of the generated addresses 139 and the original addresses 131 are inputted into the match circuit 104.
S206 The generated addresses 139 are compared with the original addresses 131 by the match circuit 104. The match circuit 104 verifies if the original addresses 131 comply with the generated addresses 139. The predictable order implied by the original addresses 131 can be determined according to a majority order implied by the plurality of the original addresses 131. The match circuit 104 outputs a recognized address 133 when the match circuit 104 determines that the generated addresses 139 comply with the predictable order implied by the original addresses 131 in one predetermined period. The recognized address 133 is selected from the generated addresses 139 which are confirmed to comply with the predictable order. In the meanwhile, the match circuit 104 outputs a match result 135 to the lock state indicator 106 for indicating the compared result of the generated addresses 139 and the original addresses 131. Depending on the match result 135 from the match circuit 104, the method goes to step S208 when the generated addresses 139 comply with the predictable order, otherwise the method goes back to step S204.
S208 The lock state indicator 106 checks whether the generated addresses 139 comply with the predictable order implied by the original addresses 131 for first predetermined times. The number count of the first predetermined times can be set based on designer or user'demand. The recognized addresses 133 are supposed to be in the lock state when the generated addresses 139 are determined to be complying with the predictable order of the original addresses 131 for the first predetermined times. Accordingly, the lock state indicator 106 outputs a lock state signal 137 to indicate the lock state of the recognized addresses 133. According to the lock state signal 137 from the lock state indicator 106, the method goes to step S210 when the generated addresses 139 are determined to be complying with the predictable order of the original addresses 131 for the first predetermined times, otherwise the method goes back to step S204. This step is used to repetitively verify the conformity between the generated address 139 and the predictable order implied by the original addresses 131 so as to lift reliability.
S210 The recognized addresses 133 are supposed to be in the lock state after the decision decided by steps 206 and 208. The increment circuit 110 outputs an incremental address 141 at a time by an ascending or descending order counted from the last recognized address 133 in response to the predictable order. The sequence generator 108 re-generates a series of generated addresses 139 accordingly.
S212 The re-generated series of generated addresses 139 are compared with the original addresses 131 by the match circuit 104. The match circuit 104 checks whether the generated addresses 139 comply with or out of the predictable order implied by the original addresses 131. The match circuit 104 outputs the match result 135 to the lock state indicator 106 for indicating the compared result of the generated addresses 139 and the original addresses 131. Depending on the match result 135 from the match circuit 104, the method goes back to step S210 if the generated addresses 139 comply with the predictable order, otherwise the method goes to step S214.
S214 The lock state indicator 106 repetitively checks whether the generated addresses 139 are out of the predictable order implied by the original addresses 131 for a second predetermined times. The number of the second predetermined times can be set based on a designer or user'demand. The recognized address 133 is supposed to be out of the lock state when the generated addresses 139 are determined to be out of the predictable order of the original addresses 131 for the second predetermined times. Accordingly, the lock state indicator 106 outputs the lock state signal 137 to indicate the lock state of the recognized addresses 133. According to the lock state signal 137 from the lock state indicator 106, the method goes back to step S204 if the generated addresses 139 are determined to be out of the predictable order of the original addresses 131 for the second predetermined times, otherwise the method goes back to step S210.

By using the method described above, the sequential order of addresses can be effectively predicted and verified, and therefore reducing the influence due to address corruption.

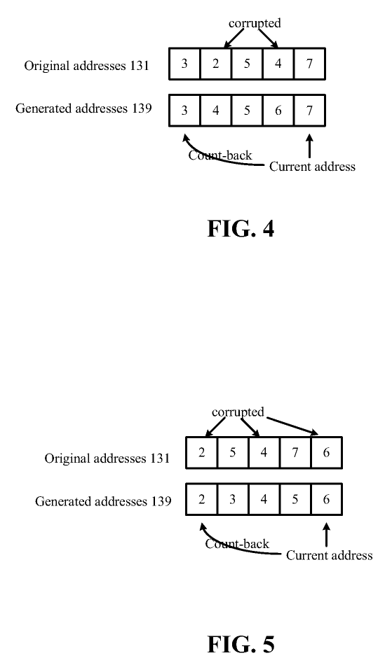

FIGS. 4-7 show the exemplary situations for checking and protecting the validity of the inputting addresses. In a first exemplary situation shown in FIG. 4, a sequence of the original addresses 131 collected by the address collection unit 102 are in an order of “3”, “2”, “5”, “4” and “7”. According to the majority order of the addresses “3”, “2”, “5”, “4” and “7”, the sequence generator 108 determines that the addresses “2” and “4” are corrupted, so the sequence generator 108 generates the generated addresses 139 as an address order of “3”, “4”, “5”, “6” and “7”, as described above. The corrupted original addresses “2” and “4” are replaced by the generated addresses “4” and “6” respectively. The last generated address “7” is treated as a recognized address if the generated addresses comply with the predictable order of the original addresses for the first predetermined times, e.g. three times.

FIG. 5 shows a second exemplary situation. The next received original address with respect to the address “7” is address “6”, which is corrupted from an correct address (i.e. address “8”), because the address order of “3”, “4”, “5”, “6” and “7” has been confirmed by the match circuit 104, so the next original address should be an address “8”. According to a majority order of the current original addresses “2”, “5”, “4”, “7” and “6”, the sequence generator 108 will generate the wrong generated addresses “2”, “3”, “4”, “5” and “6”, so the address protection circuit of the present invention needs to check the validity of the generated addresses for the first predetermined times in order to prevent the recognized address from being corrupted.

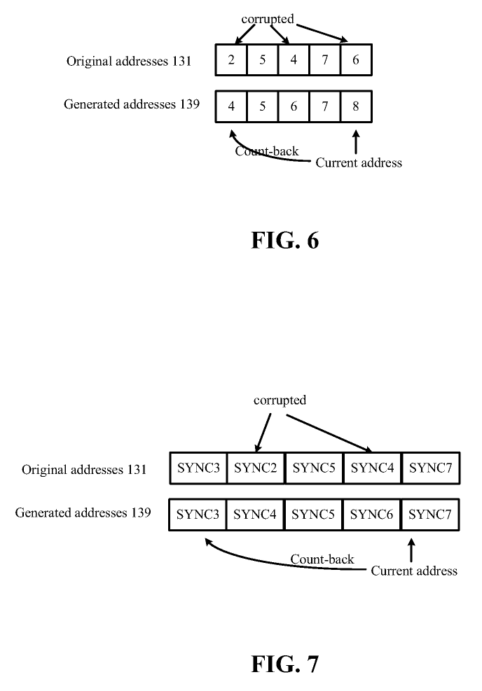

FIG. 6 shows a third exemplary situation. Although the majority order of the original addresses “2”, “5”, “4”, “7” and “6” is wrong, the sequence generator 108 can re-generate the correct generated address order of “4”, “5”, “6”, “7” and “8” by counting back or counting forward from the recognized address “7” if the generated addresses complying with the predictable order of the original addresses has been confirmed for the first predetermined times. Contrarily, the recognized address needs to be re-checked if it is found that the generated addresses are not complying with the predictable order of the original addresses for the second predetermined times.

In the exemplary situations of FIGS. 4-6, the predictable order of the original addresses is a continuous sequential order. However, the predictable order of the original addresses could be represented by other rules. Referring to a fourth exemplary situation shown in FIG. 7, a sequence of the original addresses 131 collected by the address collection unit 102 are in an order of “SYNC3”, “SYNC2”, “SYNC5”, “SYNC4” and “SYNC7”. It is noted that “SYNC” has a defined configurations to represent beginning of data of address in a block or frame. It is supposed that the predictable order is represented by an order of “SYNC0”, “SYNC1”, “SYNC2”, “SYNC3”, “SYNC4”, “SYNC5”, “SYNC6”, “SYNC7” . . . etc. Therefore, the sequence generator 108 determines that the addresses “SYNC2” and “SYNC4” are corrupted, so the sequence generator 108 generates the generated addresses 139 address order of “SYNC3”, “SYNC4”, “SYNC5”, “SYNC6” and “SYNC7”. The last generated address “SYNC7” is treated as a recognized address if the generated addresses comply with the predictable order of the original addresses for the first predetermined times. More practically, the actually address order of “SYNC1”, “SYNC2”, “SYNC3”, “SYNC4”, “SYNC5” . . . can be non-continuous but comply with other predetermined rules, for example, “SYNC1”, “SYNC3”, “SYNC5” . . . and so on.

It is noted that the address (such as the inputting addresses 130, the original addresses 131, and so on) or SYNC (such as “SYNC1”, “SYNC2”, and so on) described above can be seen as one kind of patterns, and this method prevent the corruption by deciding whether the trend of the patterns comply with a continuous sequential order or not. Therefore, the address collection unit 102 of FIG.2 could be replaced to be a pattern collection unit, and the related descriptions (including all the description, such as flowchart and exemplary situations) are omitted for simplicity.

In contrast with prior art, the address protection method and circuit of the present invention are capable of efficiently protecting inputting addresses from corruption. The address protection method and circuit in accordance with the present invention can check the predictable order of the original addresses and then generate the correct addresses by correcting the corrupted addresses within the original addresses. Therefore, the address protection method and circuit according to the present invention can improve the accuracy of the inputting addresses and increase the validity of data in response to the inputting addresses, such as the relative address in DVD-RW (Digital Versatile Disc-Rewritable) or DVD-R (Digital Versatile Disc-Recordable) systems.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. An address protection method comprising the steps of:
generating and checking a series of generated addresses according to a predictable order implied by a series of original addresses;
generating a recognized address when the generated addresses comply with the predictable order, wherein the recognized address is selected from the generated addresses;
checking whether the original addresses comply with the generated addresses for first predetermined times; and
setting the recognized address in a lock state when the original addresses comply with the generated addresses for the first predetermined times.

2. The address protection method of claim 1, after the step of setting the recognized address in the lock state, further comprising the steps of:
re-generating a series of generated addresses by using the recognized address as a reference;
checking whether the re-generated series of generated addresses are out of the predictable order for second predetermined times;
setting the recognized address to be out of the lock state if the re-generated series of generated addresses are out of the predictable order for the second predetermined times.

3. The address protection method of claim 2, wherein the generated addresses are generated by counting back from the recognized address in the lock state.

4. The address protection method of claim 2, wherein the generated addresses are re-generated by counting forward from the recognized address in the lock state.

5. The address protection method of claim 1, wherein the validity of recognized address is determined according to a majority order of the original addresses.

6. The address protection method of claim 5, wherein the majority order is a continuous sequential order.

7. The address protection method of claim 5, wherein the majority order is determined by a predetermined rule.

8. An address protection circuit comprising:
a sequence generator for generating a series of generated addresses according to a predictable order implied by a series of original addresses;
a match circuit for checking the predictable order of the original addresses and comparing the generated addresses with the original addresses for generating a match result, and the match circuit generating a recognized address when the generated addresses comply with the predictable order, wherein the recognized address is selected from the generated addresses; and
a lock state indicator for issuing a lock state signal for indicating whether the recognized address is in a lock state according to the match result, wherein the recognized address is in the lock state when the original addresses are verified to comply with the generated addresses for first predetermined times.

9. The address protection circuit of claim 8, further comprising an increment circuit for outputting incremental addresses to the sequence generator by an ascending order or descending order counted from the recognized address when the sequence generator is in the lock state, and the sequence generator re-generates a series of generated address accordingly.

10. The address protection circuit of claim 9, further comprising a multiplexer for receiving the lock state signal and controlling the sequence generator to generate the generated addresses based on the original addresses or incremental addresses according to the lock state signal.

11. The address protection circuit of claim 8, wherein the validity of recognized address is determined according to a majority order of the original addresses.

12. The address protection circuit of claim 11, wherein the majority order is a continuous sequential order.

13. The address protection circuit of claim 11, wherein the majority order is determined by a predetermined rule.

14. The address protection circuit of claim 8, wherein the generated addresses are generated by counting back from the recognized address after the sequence generator is in the lock state.

15. The address protection circuit of claim 8, wherein the generated addresses are generated by counting forward from the recognized address after the sequence generator is in the lock state.

16. A method to prevent patterns from corruption, comprising:
generating and checking a series of generated patterns according to a predictable order implied by a series of original patterns;
generating a recognized pattern when the series of generated patterns comply with the predictable order, wherein the recognized pattern is selected from the generated patterns;
checking whether the original patterns comply with the generated patterns for first predetermined times; and
setting the recognized pattern in a lock state when the original patterns comply with the generated patterns for the first predetermined times.

17. The method of claim 16, wherein the original patterns are a series of original addresses read from an optical disc.

18. The method of claim 16, wherein the original patterns are a series of “SYNC”s read from an optical disc.

19. A pattern protection circuit comprising:
a sequence generator for generating a series of generated patterns according to a predictable order implied by a series of original patterns;
a match circuit for checking the predictable order of the original patterns and comparing the generated patterns with the original patterns for generating a match result, and the match circuit generating a recognized pattern when the generated patterns comply with the predictable order, wherein the recognized pattern is selected from the generated patterns; and
a lock state indicator for issuing a lock state signal for indicating whether the recognized pattern is in a lock state according to the match result, wherein the recognized pattern is in the lock state when the original patterns are verified to comply with the generated patterns for first predetermined times.

20. The pattern protection circuit of claim 19, wherein the original patterns are a series of original addresses read from an optical disc.

21. The pattern protection circuit of claim 19, wherein the original patterns are a series of “SYNC”s read from an optical disc.
